(19) United States
(12) Patent Application Publication
(10) Pub. No.: US 2007/0128325 A1
(43) Pub. Date: Jun. 7, 2007

(54) Reduced oil dressing composition and a method for making the same

(75) Inventors: Thomas Vincent Merolla, Hillsborough, NJ (US); Jadwiga Malgorzata Bialek, XC Den Haag (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a Unilever

(21) Appl. No.: 11/294,142

(22) Filed: Dec. 5, 2005

(51) Int. Cl. A23L 1/40

(52) U.S. Cl. 426/589

(57) ABSTRACT

A dressing composition with reduced oil is described. The dressing composition has starch and optionally has insoluble fiber. The dressing composition has organoleptic properties that are similar to full fat compositions that are starch free and has oil droplets with diameters that do not exceed four (4) microns.

### FIELD OF THE INVENTION

The present invention is directed to a reduced oil dressing composition, and a method for making the same. More particularly, the invention is directed to a reduced oil dressing composition that comprises a thickening component. The composition of the present invention, surprisingly, has excellent organoleptic characteristics; and particularly, organoleptic characteristics that are better than similar dressing compositions comprising starch and substantially the same as full-fat and thickener-free dressing compositions. The invention is also directed to a method for making the above-described composition by generating a emulsion phase having small oil droplets and combining the same with a composition comprising the thickening component.

### BACKGROUND OF THE INVENTION

Edible emulsions are used as a base for many types of food products. Real mayonnaise, for example, is an edible oil-in-water-emulsion that typically has over 74% by weight oil, wherein the standard of identity for real mayonnaise requires at least 65% by weight oil.

Other ingredients used in mayonnaise include salt, emulsifier, vinegar and water. Mayonnaise is enjoyed by many consumers, and particularly, on sandwiches, in dips with fish and fries, as well as with many other food products.

The oil present in edible emulsions, like mayonnaise, is an important contributor to the taste, texture, appearance, aroma, and especially, mouthfeel and mouth dissipation characteristics of the same.

For a variety of reasons, especially those associated with caloric and fat intake, many manufacturers are removing fat from edible emulsions and replacing the fat with water and thickeners, like starch. The resulting conventional reduced oil dressing compositions typically look and taste “pasty” and do not possess many of the positive characteristics that consumers demand with emulsion comprising products like real mayonnaise.

There is a need to develop a reduced oil edible emulsion that can be used as a base for many food products, including reduced oil mayonnaise-type foodstuffs that are excellent condiments for use in fast food chains that are under great pressure to reduce fat in their products. This invention, therefore, is directed to a reduced oil dressing composition that comprises a thickening component but that surprisingly has superior organoleptic properties when compared to conventional reduced oil dressing compositions. The invention is also directed to a method for making the reduced oil composition of this invention.

Additional Information

Efforts have been made for preparing edible emulsions. In U.S. Patent Application No. 2002/0197382 A1, edible oil-in-water emulsions having a reduced content of oil are described.

Other efforts have been made for preparing edible emulsions. In U.S. Pat. No. 6,039,998, freezable and low caloric spoonable dressings with fatty acid propoxylated glycerin compositions are described.

Still other efforts have been made for preparing edible emulsions. In U.S. Pat. No. 5,690,981, low calorie foodstuffs are described.

Still other efforts have been disclosed for making edible emulsions. In U.S. applications, publication nos. US 2005/0089621 and US 2005/0089620, emulsions with insoluble fibers are described.

None of the additional information above describes a dressing composition comprising reduced levels of oil, about 1.0% or more by weight starch in the absence of a viscosity-building emulsifier and wherein the emulsion has excellent organoleptic properties such that, for example, 2 ml of the emulsion will dissipate in the mouth of a consumer within 60 seconds.

### SUMMARY OF THE INVENTION

In a first aspect, the present invention is directed to a dressing composition comprising:
(a) an emulsion; and
(b) a thickening component,
   wherein the thickening component comprises enough starch to make the dressing composition comprise from about 1.0% to about 6.5% by weight starch, and optionally enough insoluble fiber to make the dressing composition comprise from 0 to about 1.0% by weight insoluble fiber based on total weight of the dressing composition and wherein the dressing composition is substantially free of viscosity-building emulsifier and substantially all of the oil droplets present within the emulsion have a diameter which is less than about four (4) microns.

In a second aspect the invention is directed to a method for making the dressing composition of the first aspect of this invention.

Dressing composition, as used herein, means, for example, a pourable or spoonable composition, or a composition suitable to use as a sauce or dip. Illustrative non-limiting examples of the types of end uses for the dressing composition of this invention include a mayonnaise-type dressing, a salad dressing, hollandaise sauce or a cheese dip. Similar dressing composition means a dressing composition comprising about the same amount of oil and thickening component (i.e., within 10%). Thickening component means a component other than oil and an emulsifier and a component used primarily to thicken food compositions, like starches, fibers and gums. Substantially free means less than 0.1 percent by weight; and preferably, from 0 to less than 0.05 percent by weight, based on total weight of the dressing composition. Viscosity-building emulsifier, as used herein, means an emulsifier that at 2.0% by weight is partially or completely not soluble in acidified deionized water having a pH of ≦5.5 or an emulsifier that is at least about 50.0% by weight protein (preferably at least about 70% by weight protein) or both. Emulsion, as used herein, is meant to include a water-in-oil emulsion, an oil-in-water emulsion and double or multiple emulsions, and the words may be used interchangeably with the term emulsion phase. The preferred emulsion in this invention, however, is an oil-in-water emulsion.

### DETAILED DESCRIPTION OF THE PREFERRED EMBODIMENTS

The only limitation with respect to the type of oil used to make the dressing composition of this invention is that the oil is suitable for human consumption. Illustrative examples of the types of oil which may be used in this invention include, without limitation, those which are liquid at ambient temperature like avocado, mustard, coconut, cottonseed, fish, flaxseed, grape, olive, palm, peanut, rapeseed, safflower, sesame, soybean, sunflower, mixtures thereof or the like.

Other types of oils which may be used in this invention are solid at ambient temperature. Illustrative examples of the oils which are solid at room temperature and suitable for use in this invention include, without limitation, butter fat, chocolate fat, chicken fat, coconut oil, hydrogenated palm kernel oil, mixtures thereof and the like.

In a preferred embodiment, the oil used in this invention is a liquid at ambient temperature. In a most preferred embodiment, the oil used in this invention is soybean, sunflower or rapeseed oil or a mixture thereof.

The amount of oil used in the dressing composition of this invention is typically more than about 6% and less than about 65%, based on total weight of the dressing composition. Preferably, the amount of oil employed in the dressing composition is from about 15% to about 50%, and most preferably, from about 20% to about 40% by weight, based on total weight of the dressing composition and including all ranges subsumed therein.

Regarding any water used in this invention, the water can be pure water (i.e., reverse osmosis water), tap water, bottled water, deionized water, spring water, or a mixture thereof. Thus, any water used in this invention may be an aqueous solution comprising salts or minerals or both. Typically, water makes up the balance of the dressing composition of this invention.

The emulsifier used to make the dressing composition of this invention typically has an HLB of greater than about 8.0, and preferably, greater than about 11.0, and most preferably, from about 12.0 to about 18.0, including all ranges subsumed therein. Illustrative examples of such an emulsifier suitable for use in this invention include, without limitation, PEG 20 tristearate, PEG 20 trioleate, PEG 20 monostearate, PEG 20 monooleate, PEG 20 monopalmitate and PEG 20 monolaurate sorbitan, derivatives thereof, mixtures thereof or the like, as made available by, for example, ICI Surfactants under the names Tween or Span. Other emulsifiers employable in this invention are, proteins, like fruit, vegetable (e.g., pea protein), milk (e.g., whey) or soy protein, or mixtures thereof. Another type of protein suitable for use in this invention is phospholipoprotein (e.g., phospholipoprotein present in egg yolk, whole egg or enzyme modified egg), and especially, egg yolk derived phospholipoprotein modified with phospholipase A as disclosed in U.S. Pat. No. 5,028,447, the disclosure of which is incorporated herein by reference. In a most preferred embodiment, however, the emulsifier used in this invention is unmodified whole egg (i.e., egg white and egg yolk blended). Typically, the amount of emulsifier used in the dressing composition is from about 0.75% to about 20%, and preferably, from about 2% to about 15%, and most preferably, from about 3% to about 8% by weight, based on total weight of the dressing composition and including all ranges subsumed therein.

The starch suitable for use in this invention can be any starch suitable for use in a food composition. For example, starches like cook-up starch, instant starch, modified starch, unmodified starch, pregelatenized starch, tapioca flour, potato flour, wheat flour, rice flour, rye flour, or mixtures thereof may be used.

Still other starches suitable for use in this invention include, for example, corn and waxy starches. The preferred starch suitable for use in this invention is a starch, like those made commercially by National Starch and Chemical Company and E.W. Staley.

The amount of starch used in the thickening component of this invention is enough such that the resulting dressing composition comprises from about 1.0 to about 6.5%, and preferably, from about 1.5 to about 6%, and most preferably, from about 2.0 to about 5% by weight starch, based on total weight of the dressing composition and including all ranges subsumed therein.

Regarding the optional insoluble fibers suitable for use in this invention, such fibers are found, for example, in fruits, both citrus and non-citrus. Other sources of the insoluble fibers suitable for use in this invention are vegetables like legumes, and grains. Preferred insoluble fibers suitable for use in this invention can be recovered from tomatoes, peaches, pears, apples, plums, lemons, limes, oranges, grapefruits or mixtures thereof. Other preferred insoluble fibers suitable for use in this invention may be recovered from the hull fibers of peas, oats, barley, mustard, soy, or mixtures thereof. Still other fibers which may be employed include those that are plant or root-derived as well as those which are wood-derived. Typically, the dressing composition of this invention comprises from 0.0 to about 1%, and preferably, from about 0 to about 0.5%, and most preferably, from about 0.1 to about 0.3% by weight insoluble fibers, based on total weight of the dressing composition, and including all ranges subsumed therein. Such insoluble fibers are available from suppliers like J. Rettenmaier and Sohne GMBH under the Vitacel name and Herbstreith & Fox under the Herbacel name. These insoluble fibers typically have lengths from about 25 to about 400 microns, and preferably, from about 50 to 185 microns, and most preferably, from about 100 to about 165 microns, including all ranges subsumed therein. The widths of such fibers are typically between about 3.0 to about 20.0 microns, and preferably, from about 5.0 to about 10.0 microns. It is also within the scope of this invention for the insoluble fiber used to be supplied with from about 0 to 15%, and preferably, from about 0.1 to 13.5% by weight soluble fiber, based on total weight of insoluble fiber and soluble fiber and including all ranges subsumed therein.

Other optional but often preferred additives suitable for use in this invention are gums. Illustrative examples of the preferred optional gums suitable for use in this invention include cellulose, locust bean, xanthan, carrageenan, guar gum, mixtures thereof or the like. Such gums typically make up from about 0.1 to about 1%, and preferably, from about 0.1 to about 0.3% by weight of the total weight of the dressing composition, including all ranges subsumed therein.

It is particularly noted herein that if heat treatment, like pasteurization, is not desired, the dressing composition described herein may be acidified in order to inhibit microbiological growth. When acidified, the dressing composition typically has enough acidulant added so that the pH of the same is from about 2.75 to about 5.5, and preferably, from about 2.85 to about 4.75, and most preferably, from about 3.0 to about 4.50, including all ranges subsumed therein.

The only limitation with respect to the type of acidulant employed in this invention is that the acidulant is one which may be used in compositions suitable for human consumption. Illustrative examples of the types of acidulants which may be used in this invention include, without limitation, acetic acid (e.g., from vinegar), citric acid (e.g., from lemon juice), hydrochloric acid, lactic acid, malic acid, phosphoric acid, glucono-delta-lactone, mixtures thereof or the like. In a preferred embodiment, lactic acid, acetic acid, citric acid or a mixture thereof is employed. Collectively, and most often, the amount of acidulant employed does not exceed about 1.5% by weight of the total weight of the dressing composition.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30%, and most preferably, at least about 75% of the total weight of the oil used in the emulsion.

The dressing composition of this invention may be combined, if desired, with other optional additives including mustard flour, chocolate, nut paste, salt (and other spices and seasonings), vitamins, natural and/or artificial flavors, and colors (e.g., beta carotene), fruit puree, preservatives, antioxidants, chelators, meat like ham and bacon bits or particulates, buffering agents, vegetable bits or particulates, fruit bits or particulates, cheese, mixtures thereof or the like. Such optional additives, when used, collectively and typically, do not make up more than about 40% by weight of the total weight of the dressing composition.

The preferred preservatives suitable for use in this invention include sodium benzoate, potassium benzoate, potassium sorbate, sorbic acid, benzoic acid, mixtures thereof or the like. Anti-oxidants suitable for use in this invention include a tocopherol, ascorbic acid, ascorbyl palmitate, tertiary-butyl hydroquinone, mixtures thereof or the like. Chelators suitable for use in this invention include EDTA and its salts, sodium tripolyphosphate, sodium carbonate, potassium carbonate, mixtures thereof or the like.

The fruit and vegetable bits that may be used in the dressing composition of this invention are typically small enough to fit through the orifice present in a conventional squeeze bottle. The vegetable bits often include peppers, carrots, cucumbers, cabbage, onion, broccoli, mixtures thereof or the like. The fruit bits often include pears, apples, grapes, tomatoes, mixtures thereof or the like.

The cheese suitable for use in this invention can be skim, part skim or full fat cheese. Typical non-limiting examples of the types of cheese (including processed cheese) suitable for use in this invention include gouda, edam, leyden, cheddar, goat, chesire, stilton, mozzarella, cream cheese, brie, feta, tilsit, mixtures thereof and the like. When cheese is desired, it is preferred that the same be melted prior to being added.

Still other additives which may be optionally used in the dressing compositions of this invention include protein sources and sweeteners. The former include caseinate and skimmed milk powder and the latter include syrups, sucrose, glucose, saccharin, aspartame, dextrose, lactose, levelose, maltose, fructose, mixtures thereof or the like.

When preparing the dressing composition of this invention, preferably, an emulsion phase is made whereby the same comprises 1% or less (individually) by weight of all starch and gum used to make the dressing composition of this invention, but preferably, less than 0.5% by weight (individually) of all starch and gum. The emulsion phase typically can comprise all of the oil used to make the dressing composition of this invention but often comprises at least about 80%, and preferably, at least about 85% by weight of the oil used in the dressing composition. Usually, the emulsion comprises from about 15% to about 25% of all water used in the dressing composition of this invention. When optional insoluble fiber is employed, at least about 85% to about 95%, and preferably, 100% of all insoluble fiber used in the dressing composition of this invention is added to the emulsion phase, whereby less than 8%, and preferably, less than 6% of all thickening component used is added to the emulsion phase, and especially, when insoluble fiber use is desired.

In yet another preferred embodiment, preferably less than 1% by weight salt (based on total weight of the dressing composition), and most preferably, less than 0.5% by weight salt should be added to the emulsion phase, and at least about 15%, and preferably, at least about 20% to about 35% by weight of all acidulant employed in the dressing composition is added when making the emulsion phase.

When making the emulsion phase, ingredients may be added in any order. Often, however, any thickening component used in the emulsion phase is preferably added to water first, followed by the addition of preservatives isolated for the emulsion phase. The resulting pre-emulsion mixture is thoroughly mixed and milled via any conventional milling device, like a colloid mill or a high pressure homogenizer. The milling of the pre-emulsion mixture results in an emulsion wherein substantially all (i.e., at least about 95% of all oil droplets present) of the oil droplets present within the emulsion have a diameter which is less than four (4) microns, but preferably, between about 2 to about 3 microns.

The thickening component (i.e., starch phase), is often made by adding starch, and gum, if desired, to water followed by the addition of optional ingredients like acidulants and preservatives, yielding a thickening component mixture. The thickening component mixture is then thoroughly mixed to produce the thickening component used to make the dressing composition of this invention.

There is no requirement as to when the emulsion phase or thickening component is made first, and either may be made first. The only requirement is that both phases are made so that the desired dressing composition can be prepared according to this invention.

Subsequent to preparing the emulsion phase and thickening component, the same are mixed together, yielding a rough mixture. The rough mixture can then, if desired, be milled (or subjected to a homogenizer) for additional blending and to yield a smoother dressing composition. In a preferred embodiment, however, at least about 2% to about 20%, and preferably, from about 4% to about 15%, and most preferably, from about 6% to about 12% of all water used to make the dressing composition of this invention can be added as a separate aqueous phase comprising at least about 50%, and preferably, at least about 80%, and most preferably, from 85% to 100% by weight of all salt used to make the dressing composition of this invention. Also, in yet another preferred embodiment, at least about 3%, and preferably, from about 5 to about 15% by weight of all oil used in the dressing composition of this invention may be added as a distinct oil phase after the emulsion phase and thickening component are combined.

When a distinct oil phase is separately added, it is often desired to mill (or subjected to a homogenizer) the resulting oil comprising composition so that the oil added in the separate phase has a final particle size (in the final dressing composition) from about 4 to about 12 microns, and preferably, from about 6 to about 9 microns, including all ranges subsumed therein.

The viscosity of the dressing composition of this invention is typically greater than about 3,000 and less than about 150,000 centipoise. When a sauce or pourable dressing is, for example, the desired dressing composition, the viscosity of the composition is preferably from about 4,000 to about 10,000 centipoise, and most preferably, from about 4,350 to about 6,000 centipoise.

When the desired dressing composition is, for example, a filling, dip or spoonable dressing, the viscosity of the composition is preferably from about 12,000 to about 120,000 centipoise, and most preferably, from about 16,000 to about 80,000 centipoise, whereby the viscosity of the composition is measured on a Haake Rheometer (Rotovisco RV20) at room temperature using a set of concentric cylinders (or bob-in-cup) with a 1 mm gap, the bob having a diameter of 1.0 cm and length of 1.0 cm. The inner cylinder or bob starts rotating from 0 shear and ramps up to a shear rate of 134 sec⁻¹ in 542 sec. By way of comparison, the viscosity values refer to the shear rate of 10 sec⁻¹. In an especially preferred embodiment, the dressing composition of this invention is a mayonnaise-type dressing with a viscosity from about 20,000 to about 60,000 centipoise.

The packaging for the dressing composition of this invention is often a glass jar, food grade sachet or squeezable plastic bottle. Sachets are preferred for food service applications, and a plastic bottle is preferred for domestic use.

The examples below are provided to facilitate an understanding of the invention.

The examples are not intended to limit the scope of the claims.

### EXAMPLE 1

A mayonnaise-type dressing composition was made by mixing the following groups of ingredients.

A. Emulsion phase

| | Percent in Dressing |
|---|---|
| Ingredient | Composition |
| Insoluble fiber | 0.22 |
| Preservative | 0.10 |
| Water | 10.5 |
| Acidulant (50% | 0.1 |
| aqueous) | |
| Liquid egg blend | 5.0 |
| Chelator | 0.008 |
| Fruit juice | 0.090 |
| Flavor | 0.120 |
| Soybean oil | 28.00 |

B. Thickening Component

| | Percent in Dressing |
|---|---|
| Ingredient | Composition |
| Water | 37.48 |
| Gum | 0.48 |
| Starch | 3.70 |
| Acidulant (50% | 0.20 |
| aqueous) | |
| Vinegar (12%) | 1.73 |
| Sugar | 2.00 |
| Preservative | 0.088 |

C. 0il Phase

| | Percent in Dressing |
|---|---|
| Ingredient | Composition |
| Soybean oil | 3.0 |

D. Aqueous phase

| | Percent in Dressing |
|---|---|
| Ingredient | Composition |
| Water | 5.5 |
| Salt | 1.75 |

The mayonnaise-type dressing composition was prepared by subjecting the emulsion phase to a mill and milling the same until substantially all oil droplets present in the resulting oil-in-water emulsion had a diameter of about 2.5 microns. Thickening component was added to the emulsion phase and the resulting mixture was further milled in order to make a homogeneous composition. The oil and water phases were then added, followed by additional milling to the point where the oil provided from the oil phase had a particle diameter of about eight (8) microns. The resulting dressing composition was a mayonnaise-type composition with excellent organoleptic properties.

### EXAMPLE 2

Mayonnaise-type compositions, similar to those prepared in Example 1, were compared (by panelists) to conventional reduced-oil mayonnaise-type compositions (i.e., Kraft's Miracle Whip®) made with about 4% by weight starch and Helimann's® Real Mayonnaise as made commercially available by Unilever. The panelists unanimously concluded that the mayonnaise-type compositions of this invention, unexpectedly, had surface shine, visible firmness and texture characteristics substantially the same as that of HelImann's® Real Mayonnaise. The mayonnaise-type compositions of this invention were also ingested by the panelists whereby 2 ml of the same dissipated in the mouths of the panelists within 60 seconds and in a manner similar to that of the real mayonnaise.

The panelists also unexpectedly concluded that the mayonnaise-type composition of this invention (having reduced oil and starch) did not look dull and pasty and did not fail to quickly dissipate in the mouth as did the conventionally sold reduced-oil composition.

What is claimed is:

1. A dressing composition comprising:
(a) an emulsion; and
(b) a thickening component
wherein the thickening component comprises enough starch to make the dressing composition comprise from about 1.0% to about 6.5% by weight starch, and optionally enough insoluble fiber to make the dressing composition comprise from 0 to about 1.0% by weight insoluble fiber based on total weight of the dressing composition and further wherein the dressing composition is substantially free of viscosity-building emulsifier and substantially all of oil droplets present within the emulsion have a diameter which is less than about four (4) microns.

2. The dressing composition according to claim 1 wherein the composition comprises from about 6 to about 65% by weight oil.

3. The dressing composition according to claim 1 wherein the dressing composition comprises from about 0.1 to about 0.25% by weight insoluble fiber.

4. The dressing composition according to claim 1 wherein the dressing composition comprises from about 1.5 to about 6% by weight starch.

5. The dressing composition according to claim 3 wherein the insoluble fiber is present with soluble fiber.

6. The dressing composition according to claim 1 wherein the dressing composition comprises from about 15 to about 50% by weight oil.

7. The dressing composition according to claim 1 wherein the dressing composition comprises from about 20 to about 40% by weight oil.

8. The dressing composition according to claim 1 wherein the dressing composition comprises from about 0.75 to about 20% by weight emulsifier.

9. The dressing composition according to claim 1 wherein the dressing composition has a pH from about 2.75 to about 5.5.

10. A method for making a dressing composition, comprising in no particular order, the steps of:
(a) preparing an emulsion with oil droplets having diameters of less than four (4) microns;
(b) preparing a thickening component; and
(c) mixing the emulsion and thickening component
wherein the thickening component comprises enough starch to make the dressing composition comprise from about 1.0% to about 6.5% by weight starch, and optionally enough insoluble, fiber to make the dressing composition comprise from about 0 to about 1.0% by weight insoluble fiber based on total weight of the dressing composition, and further wherein the dressing composition is substantially free of viscosity-building emulsifier.

11. The method according to claim 10 wherein the emulsion is subjected to a mill or homogenizer prior to being mixed with the thickening component.

12. The method according to claim 10 wherein the oil droplets have diameters from about 2 to about 3 microns.

13. The method according to claim 10 wherein the thickening component comprises enough insoluble fiber to make the dressing composition comprise 0.1 to 0.3% by weight insoluble fiber.

14. The method according to claim 10 wherein from about 5 to about 15% of all oil used in the dressing composition is added after the emulsion and thickening component have been mixed to produce an oil comprising composition.

15. The method according to claim 14 wherein the oil comprising composition is milled or homogenized to reduce the diameter of the oil added after the emulsion and thickening component have been mixed to about 5 to about 15 microns.

16. The method according to claim 10 wherein the thickening component further comprises gum.

17. The method according to claim 10 wherein from about 3 to about 20% by weight of all water used in the dressing composition is added as a separate phase.

18. The method according to claim 17 wherein the separate phase comprises at least about 50% by weight of all salt used to make the dressing composition.
